(19) United States
(12) Patent Application Publication
(10) Pub. No.: US 2017/0325150 A1
(43) Pub. Date: Nov. 9, 2017

(54) BASE STATION AND PROCESSOR

(71) Applicant: KYOCERA CORPORATION, Kyoto (JP)

(72) Inventors: Katsuhiro MITSUI, Kawasaki-shi, Kanagawa (JP); Yushi NAGASAKA, Yokohama-shi, Kanagawa (JP)

(73) Assignee: KYOCERA CORPORATION, Kyoto (JP)

(21) Appl. No.: 15/523,797

(22) PCT Filed: Nov. 5, 2015
(86) PCT No.: PCT/JP2015/081210

§ 371 Date: May 2, 2017

(30) Foreign Application Priority Data
Nov. 7, 2014 (JP) 2014-227438

(51) Int. Cl. H04W 36/38; H04W 36/30; H04W 36/26; H04W 36/32; H04W 36/14

(52) U.S. Cl. CPC H04W 36/385; H04W 36/32; H04W 36/14; H04W 36/26; H04W 36/30

(57) ABSTRACT

A base station according to an embodiment constitutes a mobile communication network. The base station comprises: a controller configured to perform at least either one of load distribution controls of a first control in which a parameter is set to a value by which switching from the mobile communication network to a wireless LAN is performed easier than a predetermined value or a second control in which a predetermined radio terminal, out of radio terminals subordinate to the base station, is allowed to perform handover; and a transmitter configured to transmit status information indicating whether or not the base station is performing the load distribution control, to a neighboring base station. The parameter is used for determining whether or not the radio terminal subordinate to the base station switches a standby target or a connection target between the mobile communication network and the wireless LAN.

### TECHNICAL FIELD

The present application relates to a base station and a processor used in a system configured to perform a switching process of switching a standby target or a connection target between a coverage area of a mobile communication network and a coverage area of a wireless LAN.

### BACKGROUND ART

Conventionally, there is proposed, if a coverage area of a mobile communication network represented by LTE (Long Term Evolution) and a coverage area of a wireless LAN overlap at least partially, a switching process (a network selection and a traffic steering) of switching, by a radio terminal, a standby target or a connection target between the mobile communication network and the wireless LAN (see Non Patent Literature 1, for example). The radio terminal determines the switching process on the basis of a determination parameter notified from a base station in the mobile communication network.

Incidentally, if the base station has a high load, the base station may set the determination parameter to a value by which the switching process to the wireless LAN is performed easily. This enables the base station to reduce the load on the base station itself. Further, the base station may not only set the determination parameter to a value by which the switching process to the wireless LAN is performed easily but also perform a control to allow a predetermined radio terminal in a cell of the base station to perform handover so as to enable reduction in load on the base station itself.

### CITATION LIST

### Non Patent Literature

Non Patent Literature 1: 3GPP Technical Specification “TS 36.304 V12.2.0” Sep. 23, 2014

### SUMMARY OF THE INVENTION

A base station according to an embodiment constitutes a mobile communication network. The base station comprises: a controller configured to perform at least either one of load distribution controls of a first control in which a parameter is set to a value by which switching from the mobile communication network to a wireless LAN is performed easier than a predetermined value or a second control in which a predetermined radio terminal, out of radio terminals subordinate to the base station, is allowed to perform handover; and a transmitter configured to transmit status information indicating whether or not the base station is performing the load distribution control, to a neighboring base station. The parameter is used for determining whether or not the radio terminal subordinate to the base station switches a standby target or a connection target between the mobile communication network and the wireless LAN.

A base station according to an embodiment is a base station that constitutes a mobile communication network, comprises: a controller configured to perform at least either one of load distribution controls of a first control in which a parameter is set to a value by which switching from the mobile communication network to a wireless LAN is performed easier than a predetermined value or a second control in which a predetermined radio terminal, out of radio terminals subordinate to the base station, is allowed to perform handover; a receiver configured to receive a handover request from another base station; and a transmitter configured to transmit, if rejecting the handover request, a response to the handover request, where the response is a negative acknowledgment including a rejection reason indicating that the load distribution control is being performed. The parameter is used for determining whether or not the radio terminal subordinate to the base station switches a standby target or a connection target between the mobile communication network and the wireless LAN.

A processor according to an embodiment is a processor for controlling a base station that constitutes a mobile communication network. The processor executes: a process of performing at least either one of load distribution controls of a first control in which a parameter is set to a value by which switching from the mobile communication network to a wireless LAN is performed easier than a predetermined value or a second control in which a predetermined radio terminal, out of radio terminals subordinate to the base station, is allowed to perform handover; and a process of transmitting status information indicating whether or not the base station is performing the load distribution control, to a neighboring base station. The parameter is used for determining whether or not the radio terminal subordinate to the base station switches a standby target or a connection target between the mobile communication network and the wireless LAN.

A processor according to an embodiment is a processor for controlling a base station that constitutes a mobile communication network. The processor executes: a process of performing at least either one of load distribution controls of a first control in which a parameter is set to a value by which switching from the mobile communication network to a wireless LAN is performed easier than a predetermined value or a second control in which a predetermined radio terminal, out of radio terminals subordinate to the base station, is allowed to perform handover; a process of receiving a handover request from another base station; and a process of transmitting, if rejecting the handover request, a response to the handover request, where the response is a negative acknowledgment including a rejection reason indicating that the load distribution control is being performed. The parameter is used for determining whether or not the radio terminal subordinate to the base station switches a standby target or a connection target between the mobile communication network and the wireless LAN.

### BRIEF DESCRIPTION OF DRAWINGS

FIG. 1 is a diagram illustrating a communication system 1 according to each embodiment.

FIG. 2 is a block diagram illustrating a radio terminal 10 according to each embodiment.

FIG. 3 is a block diagram illustrating a radio base station 100 according to each embodiment.

FIG. 4 is a block diagram illustrating an access point 200 according to each embodiment.

FIG. 5 is a diagram for describing an example of an operation environment.

FIG. 6 is a diagram for describing an example of an operation environment.

FIG. 7 is a diagram for describing an example of an operation according to a first embodiment.

FIG. 8 is a diagram for describing an example of an operation according to a modification of a second embodiment.

### DESCRIPTION OF EMBODIMENTS

### Overview of Embodiment

A case is assumed where a base station that sets a determination parameter to a value by which the switching process to a wireless LAN is performed easily receives a handover request from another base station.

In this case, even if the base station rejects the handover request in order to avoid an increase in load, the base station may repeatedly receive the handover request from the other base station that does not know the situation of the base station.

Further if the base station approves the handover request from the other base station, it is highly likely that a radio terminal that performs the handover to the base station immediately performs the switching process to the wireless LAN on the basis of the determination parameter of the base station. If an access point to which the radio terminal that performs the switching process connects is located in an overlapping portion between a coverage area of the base station and a coverage area of the other base station, the radio terminal is capable of performing the switching process for connecting from the other base station to the access point without a need of executing the handover as a result of which there may be an unnecessary handover request transmission.

It is noted that in addition to a case where the determination parameter is set to a value by which the switching process to the wireless LAN is performed easily, also in a case where the control to allow a predetermined radio terminal within a cell of the base station to perform handover is performed, such an unnecessary handover request transmission may be performed.

Therefore, an object of the present application is to enable reduction of an unnecessary handover request transmission.

A base station according to a first embodiment (and other embodiment) is a base station that constitutes a mobile communication network. The base station comprises: a controller configured to perform at least either one of load distribution controls of a first control in which a parameter is set to a value by which switching from the mobile communication network to a wireless LAN is performed easier than a predetermined value or a second control in which a predetermined radio terminal, out of radio terminals subordinate to the base station, is allowed to perform handover; and a transmitter configured to transmit status information indicating whether or not the base station is performing the load distribution control, to a neighboring base station. The parameter is used for determining whether or not the radio terminal subordinate to the base station switches a standby target or a connection target between the mobile communication network and the wireless LAN.

In the first embodiment, the transmitter transmits the status information to the neighboring base station together with load information of the base station.

In the first embodiment, the status information includes information indicating a degree of the load distribution control.

In the first embodiment, the status information is information indicating that the first control is being performed and/or information indicating that the second control is being performed.

In the first embodiment, if the load distribution control is the first control, the status information includes information indicating the parameter.

In the first embodiment, if the load distribution control is the first control, the status information includes information indicating the number of radio terminals to which the parameter is set by a dedicated signal.

In the first embodiment, if the load distribution control is the first control, the status information includes information indicating the number of radio terminals that perform the switching.

In the first embodiment, if the load distribution control is the first control, the status information includes an identifier indicating a wireless LAN access point that is a candidate of the standby target or the connection target.

A base station according to a second embodiment (and other embodiment) is a base station that constitutes a mobile communication network, comprises: a controller configured to perform at least either one of load distribution controls of a first control in which a parameter is set to a value by which switching from the mobile communication network to a wireless LAN is performed easier than a predetermined value or a second control in which a predetermined radio terminal, out of radio terminals subordinate to the base station, is allowed to perform handover; a receiver configured to receive a handover request from another base station; and a transmitter configured to transmit, if rejecting the handover request, a response to the handover request, where the response is a negative acknowledgment including a rejection reason indicating that the load distribution control is being performed. The parameter is used for determining whether or not the radio terminal subordinate to the base station switches a standby target or a connection target between the mobile communication network and the wireless LAN.

In the first embodiment, the transmitter transmits, if a reason for the handover request is a load distribution, the negative acknowledgment including the rejection reason indicating that the load distribution control is being performed.

A processor according to a first embodiment (and other embodiment) is a processor for controlling a base station that constitutes a mobile communication network. The processor executes: a process of performing at least either one of load distribution controls of a first control in which a parameter is set to a value by which switching from the mobile communication network to a wireless LAN is performed easier than a predetermined value or a second control in which a predetermined radio terminal, out of radio terminals subordinate to the base station, is allowed to perform handover; and a process of transmitting status information indicating whether or not the base station is performing the load distribution control, to a neighboring base station. The parameter is used for determining whether or not the radio terminal subordinate to the base station switches a standby target or a connection target between the mobile communication network and the wireless LAN.

A processor according to a second embodiment (and other embodiment) is a processor for controlling a base station that constitutes a mobile communication network. The processor executes: a process of performing at least either one of load distribution controls of a first control in which a parameter is set to a value by which switching from the mobile communication network to a wireless LAN is performed easier than a predetermined value or a second control in which a predetermined radio terminal, out of radio terminals subordinate to the base station, is allowed to perform handover; a process of receiving a handover request from another base station; and a process of transmitting, if rejecting the handover request, a response to the handover request, where the response is a negative acknowledgment including a rejection reason indicating that the load distribution control is being performed. The parameter is used for determining whether or not the radio terminal subordinate to the base station switches a standby target or a connection target between the mobile communication network and the wireless LAN.

### First Embodiment

(Communication System)

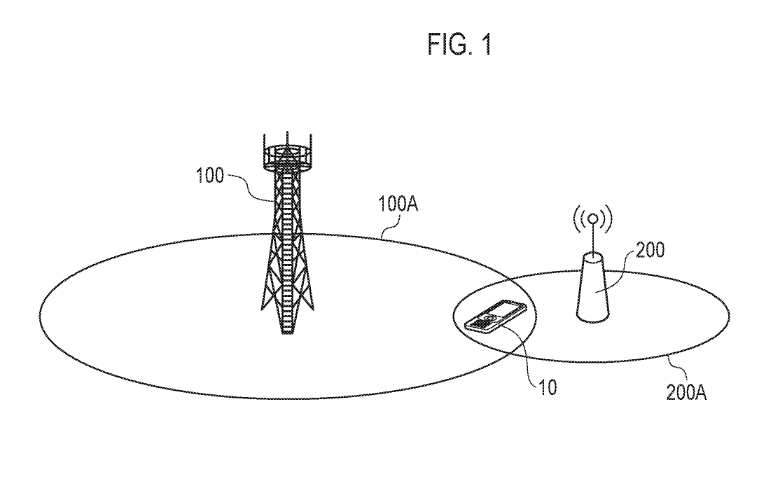

A communication system according to a first embodiment will be described, below. FIG. 1 is a diagram showing a communication system 1 according to the first embodiment.

As shown in FIG. 1, the communication system 1 includes a radio base station 100 and an access point 200. Further, the communication system 1 includes a radio terminal 10 capable of connecting to the radio base station 100 or the access point 200.

The radio terminal 10 is a terminal such as a cell phone or a tablet computer. The radio terminal 10 has a function of performing radio communication with the access point 200, in addition to a function of performing radio communication with the radio base station 100.

The radio base station 100 has a first coverage area 100A, and in the first coverage area 100A, provides a mobile communication service represented by LTE (Long Term Evolution). The radio base station 100 manages one or a plurality of cells, and the first coverage area 100A is configured by one or a plurality of cells. The radio base station 100 is an entity of a mobile communication network. It is noted that a cell may be thought of as a term to indicate a geographical area, and may also be thought of as a function of performing radio communication with the radio terminal 10.

The access point 200 has a second coverage area 200A, and in the second coverage area 200A, provides a wireless LAN service. The access point 200 is an entity of a wireless LAN. At least a part of the second coverage area 200A overlaps the first coverage area 100A. A whole of the second coverage area 200A may overlap the first coverage area 100A. Generally, the second coverage area 200A is smaller than the first coverage area 100A.

(Application Scene)

In the first embodiment, a method of performing, by the radio terminal, the switching process (for example, a network selection and a traffic steering) of switching a standby target or a connection target between a mobile communication network and a wireless LAN, will be described. The radio terminal 10 in an RRC connected state or an RRC idle state performs a switching process in order to select a network in which data (packet) is exchanged, out of a mobile communication network (cellular communication network) and a wireless LAN (WLAN communication network). Specifically, when a state is continued over a predetermined period where first information at a mobile communication network side satisfies a first condition and second information at a wireless LAN side satisfies a second condition, the switching process (for example, a network selection and a traffic steering) is executed.

In the first embodiment, the switching process includes both of: a process of switching a standby target or a connection target from a mobile communication network to a wireless LAN, and a process of switching a standby target or a connection target from the wireless LAN to the mobile communication network.

Here, the first information at the mobile communication network side is a measurement result (RSRPmeas) of a signal level of a received signal (RSRP: Reference Signal Received Power) and a measurement result (RSRQmeas) of a signal quality of a received signal (RSRQ: Reference Signal Received Quality), for example.

The second information at the wireless LAN side is a channel utilization value of a wireless LAN (ChannelUtilizationWLAN), a backhaul value of a downlink of a wireless LAN (BackhaulRateDIWLAN), a backhaul value of an uplink of a wireless LAN (BackhaulRateUIWLAN), and a signal level of a received signal (RSSI: Received Signal Strength Indicator), for example.

(Switching Process from Mobile Communication Network to Wireless LAN)

A first condition that the standby target or the connection target is switched from the mobile communication network to the wireless LAN is that either one of the following condition (1a) or (1b) is satisfied, for example. It is noted that the first condition may be that all of the following conditions (1a) to (1b) are satisfied.

(1a) RSRPmeas<Thresh_{ServingOffloadWLAN, LowP}

(1b) RSRQmeas<Thresh_{ServingOffloadWLAN, LowQ}

It is noted that “Thresh_{ServingOffloadWLAN, LowP}” and “Thresh_{ServingOffloadWLAN, LowQ}” are threshold values provided from the radio base station 100 or previously determined threshold values.

A second condition that the standby target or the connection target is switched from the mobile communication network to the wireless LAN is that all of the following conditions (1c) to (1f) are satisfied, for example. It is noted that the second condition may be that any one of the following conditions (1c) to (1f) is satisfied.

(1c) ChannelUtilizationWLAN<Thresh_{ChUtilWLAN, Low}

(1d) BackhaulRateDlWLAN>Thresh_{BackhRateDLWLAN, High}

(1e) BackhaulRateUlWLAN>Thresh_{BackhRateULWLAN, High}

(1f) RSSI>Thresh_{BEACONSRSSI, High}

It is noted that “Thresh_{ChUtilWLAN, Low}”, “Thresh_{BackhRateDLWLAN, High}”, “Thresh_{BackhRateULWLAN, High}”, and “Thresh_{BEACONSRSSI, High}” are threshold values provided from the base station 100 or previously determined threshold values.

(Switching Process from Wireless LAN to Mobile Communication Network)

A first condition that the standby target or the connection target is switched from the wireless LAN to the mobile communication network is that the following conditions (2a) and (2b) are satisfied, for example. It is noted that the first condition may be that either one of the following condition (2a) or (2b) is satisfied.

(2a) RSRPmeas>Thresh_{ServingOffloadWLAN, HighP}

(2b) RSRQmeas>Thresh_{ServingOffloadWLAN, HighQ}

It is noted that “Thresh_{ServingOffloadWLAN, HighP}” and “Thresh_{ServingOffloadWLAN, HighQ}” are threshold values provided from the base station 100 or previously determined threshold values.

A second condition that the standby target or the connection target is switched from the wireless LAN to the mobile communication network is that any one of the following conditions (2c) to (2f) is satisfied, for example. It is noted that the second condition may be that all of the following conditions (2c) to (2f) are satisfied.

(2c) ChannelUtilizationWLAN>Thresh_{ChUtilWLAN, High}

(2d) BackhaulRateDlWLAN<Thresh_{BackhRateDLWLAN, Low}

(2e) BackhaulRateUlWLAN<Thresh_{BackhRateULWLAN, Low}

(2f) RSSI<Thresh_{BEACONSRSSI, Low}

It is noted that “Thresh_{ChUtilWLAN, High}”, “Thresh_{BackhRateDLWLAN, Low}”, “Thresh_{BackhRateULWLAN, Low}”, and “Thresh_{BEACONSRSSI, Low}” are threshold values provided from the base station 100 or previously determined threshold values.

It is noted that when the above-described threshold values are not provided, the radio terminal 10 may omit to acquire (that is, receive or measure) information in which the threshold values are not provided.

In the first embodiment, the above-described various types of threshold values are examples of a determination parameter (for example, a RAN assistance parameter) for determining whether or not to perform the switching process of switching the standby target or the connection target between the mobile communication network and the wireless LAN. That is, the determination parameter includes one or more values selected from among “Thresh_{ServingOffloadWLAN, LowP}”, “Thresh_{ServingOffloadWLAN, LowQ}”, “Thresh_{ChUtilWLAN, Low}”, “Thresh_{BackhRateDLWLAN, High}”, “Thresh_{BackhRateULWLAN, High}”, “Thresh_{BEACONSRSSI, High}”, “Thresh_{ServingOffloadWLAN, HighP}”, “Thresh_{ServingOffloadWLAN, HighQ}”, “Thresh_{ChUtilWLAN, High}”, “Thresh_{BackhRateDLWLAN, Low}”, “Thresh_{BackhRateULWLAN, Low}”, and “Thresh_{BEACONSRSSI, Low}”.

Further, the determination parameter may include a predetermined period (TsteeringWLAN) during which a state in which the radio terminal satisfies the first condition or the second condition should be continued. Alternatively, when an offload process of switching, by the radio terminal, the standby target or the connection target from the mobile communication network to the wireless LAN is performed, the determination parameter may include a below-described predetermined period (T350 timer value) that the radio terminal 10 should hold.

The determination parameter includes an individual parameter individually notified from the radio base station 100 to the radio terminal 10 and a broadcast parameter broadcast from the radio base station 100 to the radio terminal 10. The individual parameter is included in an RRC message (for example, RRC Connection Reconfiguration) transmitted from the radio base station 100 to the radio terminal 10, for example. The broadcast parameter is included in an SIB (for example, WLAN-OffloadConfig-r12) broadcast from the radio base station 100, for example. It should be noted that when receiving the individual parameter in addition to the broadcast parameter, the radio terminal 10 preferentially applies the individual parameter over the broadcast parameter.

(Radio Terminal)

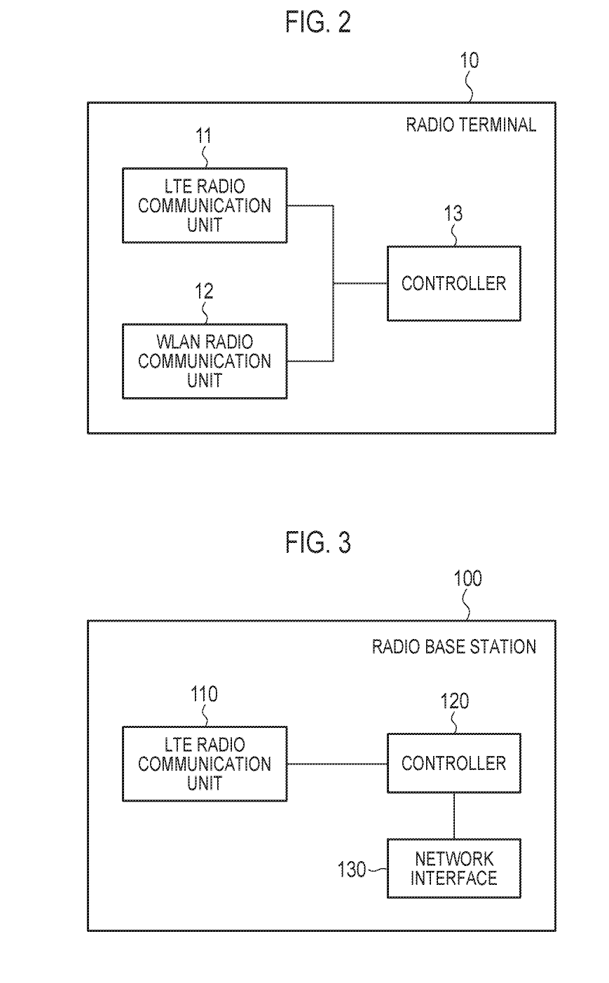

A radio terminal according to the first embodiment will be described, below. FIG. 2 is a block diagram showing the radio terminal 10 according to the first embodiment.

As shown in FIG. 2, the radio terminal 10 includes an LTE radio communication unit (transmitter/receiver) 11, a WLAN radio communication unit (transmitter/receiver) 12, and a controller 13.

The LTE radio communication unit 11 has a function of performing radio communication with the radio base station 100, and is configured by a radio transceiver, for example. For example, the LTE radio communication unit 11 regularly receives a reference signal from the radio base station 100. The LTE radio communication unit 11 regularly measures a signal level of a reference signal (RSRP) and a signal quality of a reference signal (RSRQ). The LTE radio communication unit 11 receives, as the determination parameter, the individual parameter and the broadcast parameter from the radio base station 100.

The WLAN radio communication unit 12 has a function of performing radio communication with the access point 200, and is configured by a radio transceiver, for example. For example, the WLAN radio communication unit 12 receives a beacon or probe response from the access point 200. The beacon or probe response includes a BBS Load information element, the channel utilization value of the wireless LAN (ChannelUtilizationWLAN) may be acquired from the BBS Load information element.

The WLAN radio communication unit 12 receives a response (GAS Response) returned from the access point 200 in response to a request (GAS (Generic Advertisement Service) Request) for the access point 200. The response (GAS Response) includes a backhaul value of a downlink of a wireless LAN (BackhaulRateDlWLAN) and a backhaul value of an uplink of a wireless LAN (BackhaulRateUlWLAN). Such an inquiry procedure is performed in accordance with ANQP (Access Network Query Protocol) defined in Hotspot2.0 of WFA (Wi-Fi Alliance).

The WLAN radio communication unit 12 receives a signal from the access point 200. The WLAN radio communication unit 12 measures a signal level of the received signal (RSSI). The signal level of the received signal (RSSI) is a signal intensity of the beacon or probe response.

The controller 13 is configured by a CPU (processor), a memory, and the like, and controls the radio terminal 10. Specifically, the controller 13 controls the LTE radio communication unit 11 and the WLAN radio communication unit 12. Further, when a state is continued over a predetermined period where the first information at the mobile communication network side satisfies the first condition and the second information at the wireless LAN side satisfies the second condition, the controller 13 executes a switching process of switching the standby target or the connection target between the mobile communication network and the wireless LAN.

When executing an onload process (or a re-offload process) of switching the standby target or the connection target from the wireless LAN to the mobile communication network after performing an offload process of switching the standby target or the connection target from the mobile communication network to the wireless LAN, the controller 13 discards the individual parameter.

In particular, as a principle, the controller 13 is configured to hold the individual parameter, in a period (T350 timer value) during which the predetermined timer (the above-described (T350 timer)) activated by the radio terminal 10 during transition to an idle state along with the offload process is activated. In other words, the controller 13 is configured to discard the individual parameter when the predetermined timer expires or the predetermined timer stops.

(Radio Base Station)

The radio base station according to the first embodiment will be described, below. FIG. 3 is a block diagram showing the radio base station 100 according to the first embodiment.

As shown in FIG. 3, the radio base station 100 includes an LTE radio communication unit (transmitter/receiver) 110, a controller 120, and a network interface (transmitter/receiver) 130.

The LTE radio communication unit 110 has a function of performing radio communication with the radio terminal 10. For example, the LTE radio communication unit 110 regularly transmits a reference signal to the radio terminal 10. The LTE radio communication unit 110 is configured by a radio transceiver, for example. The LTE radio communication unit 110 transmits, as the determination parameter, the individual parameter and the broadcast parameter to the radio terminal 10. As described above, the LTE radio communication unit 110 notifies the radio terminal 10, by an RRC message (for example, RRC Connection Reconfiguration), of the individual parameter, and notifies the radio terminal 10, by an SIB (for example, WLAN-OffloadConfig-r12), of the broadcast parameter.

The controller 120 is configured by a CPU (processor), a memory, and the like, and controls the radio base station 100. Specifically, the controller 120 controls the LTE radio communication unit 110 and the network interface 130. It is noted that a memory configuring the controller 120 may function as a storage unit, and in addition to the memory configuring the controller 120, a memory configuring the storage unit may be arranged.

The network interface 130 is connected to a neighboring base station via the X2 interface and is connected to an MME/S-GW via an S1 interface. The network interface 130 is used in communication performed on the X2 interface and communication performed on the S1 interface. Further, the network interface 130 may be connected via a predetermined interface to the access point 200. The network interface 130 is used for communication with the access point 200.

(Access Point)

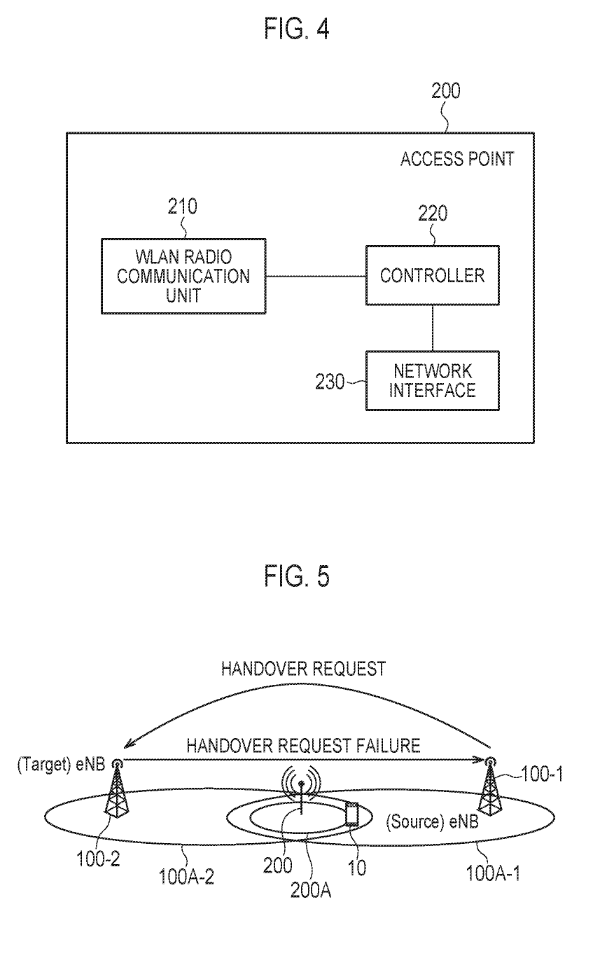

The access point according to the first embodiment will be described, below. FIG. 4 is a block diagram showing the access point 200 according to the first embodiment.

As shown in FIG. 4, the access point 200 includes a WLAN radio communication unit (transmitter/receiver) 210, a controller 220, and a network interface (transmitter/receiver) 230.

The WLAN radio communication unit 210 has a function of performing radio communication with the radio terminal 10, and has a similar function to the WLAN radio communication unit 12 of the radio terminal 10. It is noted that the WLAN radio communication unit 210 receives a connection request from the radio terminal 10. Further, the WLAN radio communication unit 210 transmits a response to the connection request, to the radio terminal 10.

The controller 220 is configured by a CPU (processor), a memory, and the like, and controls the access point 200. Specifically, the controller 220 controls the WLAN radio communication unit 210 and the network interface 230. It is noted that a memory configuring the controller 220 may function as a storage unit, and in addition to the memory configuring the controller 220, a memory configuring the storage unit may be arranged.

The network interface 230 is connected, via a predetermined interface, to a backhaul. The network interface 230 is used for communication with the radio base station 100. Further, the network interface 230 may be directly connected via a predetermined interface to the radio base station 100.

(Determination of Switching Process)

Determination of the switching process will be described by using a process of switching from the mobile communication network to the wireless LAN, for example, below.

Firstly, a method of determining whether or not a state where the first information satisfies the first condition is continued over a predetermined period (TsteeringWLAN) will be described. The first information is a measurement result (RSRPmeas) of a signal level (RSRP) of a reference signal or a measurement result (RSRQmeas) of a signal quality (RSRQ) of a reference signal, the reference signal is received regularly in a short cycle, and the RSRPmeas or the RSRQmeas is measured in a relatively short cycle. That is, the RSRPmeas or the RSRQmeas is acquired continuously in a time-axis direction.

Secondly, a method of determining whether or not a state where the second information satisfies the second condition is continued over a predetermined period (TsteeringWLAN) will be described. There is no fixed rule about a cycle in which the second information is acquired. That is, the second information (for example, BackhaulRateDlWLAN or BackhaulRateUlWLAN) is acquired discretely in a time-axis direction.

(Operation According to First Embodiment)

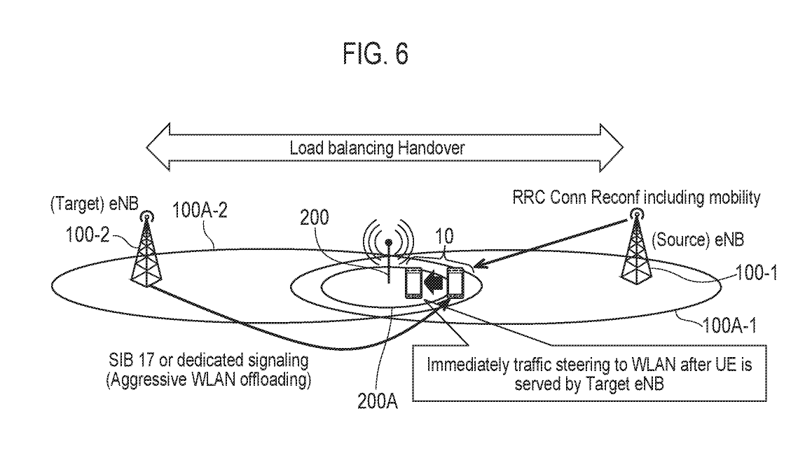

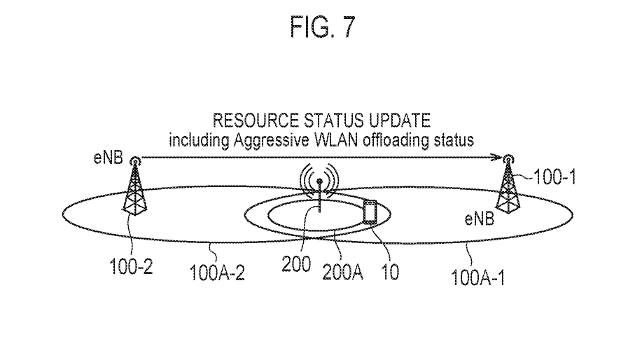

Next, an operation according to the first embodiment will be described with reference to FIG. 5 to FIG. 7. FIG. 5 and FIG. 6 are diagrams for describing an example of an operation environment. FIG. 7 is a diagram for describing an example of an operation according to the present embodiment.

As illustrated in FIG. 5, a first coverage area 100A-1 of a cell managed by a radio base station 100-1 and a first coverage area 100A-2 of a cell managed by a radio base station 100-2 overlap. Further, in the overlapping portion between the first coverage area 100A-1 and the first coverage area 100A-2, there is a second coverage area 200A provided in the access point 200. In the overlapping portion between the first coverage areas 100A-1 and 100A-2, there is the access point 200. It is noted that the second coverage area 200A may be located in a state of partially overlapping in the overlapping portion between the first coverage area 100A-1 and the second coverage area 100A-2.

A radio terminal 10-1 exists in the first coverage area 100A-1. “Existing” may include a standby state (RRC idle state) for a cell managed by the radio base station 100-1 and a connected state (RRC connected state) of being connected to the cell managed by the radio base station 100-1. In the mobile communication network, the radio terminal 10 is in the standby state or in the connected state.

In the present embodiment, the radio base station 100-1 and the radio base station 100-2 transmit, by SIB or dedicated signaling, a determination parameter for determining whether or not to perform an offload process of switching the standby target or the connection target from the mobile communication network to the wireless LAN, to the radio terminal subordinate to the base station itself (that is, in an own cell). Further, In the present embodiment, the radio base station 100-1 and the radio base station 100-2 transmit, by the SIB, a list of identifiers indicating the access point 200 that is a candidate of the standby target or the connection target in the wireless LAN (hereinafter, WLANID list), to the radio terminal in the own cell. The radio terminal 10 autonomously determines, on the basis of a radio signal and the determination parameter from the access point 200 indicated by the identifier within the WLANID list received from the radio base station 100-1, whether to perform the offload process.

Further, in the present embodiment, a case is assumed where in the radio base station 100-2, a load of the radio base station 100-2 is high, and thus, the determination parameter is set to a value by which an offload process is performed more easily as compared to a predetermined value. Specifically, in the radio base station 100-2, the determination parameter is set to a value smaller (or larger) than a predetermined value. The predetermined value may be a previously set value (initial value or the like), for example, and may be an average value of the determination parameter. Alternatively, the radio base station 100-2 may set a registered value registered as a value by which an offload process is performed easily, to the value of the determination parameter. Alternatively, the radio base station 100-2 is a server device managed by an operator, and may set a value by which an offload process designated by OAM configured to perform maintenance and monitoring of the E-UTRAN is performed easily, to the value of the determination parameter.

If the radio base station 100-2 sets such a determination parameter, a state of the radio base station 100-2 is a state where load distribution control for reducing the number of radio terminals in the cell of the radio base station 100-2 is being performed. For example, if the load of the radio base station 100-2 exceeds a threshold value, the radio base station 100-2 transitions from a normal state to a state where the load distribution control is being performed.

Here, as illustrated in FIG. 5, a case is assumed where in order that the radio terminal 10 is allowed to perform the handover, the radio base station 100-1 transmits a handover request (HANDOVER REQUEST) to the radio base station 100-2. As described above, the radio base station 100-2 is performing the load distribution control; however, if the load is still high, the radio base station 100-2 transmits, to the radio base station 100-1, a response to the handover request in which the handover request is rejected (HANDOVER REQUEST FAILURE). In particular, if a load distribution is a purpose of the handover request, it is highly likely that the radio base station 100-2 having a high load transmits the response to the handover request in which the handover request is rejected.

Further, the number of radio terminals that perform the offload process to the wireless LAN is larger than usual, and thus, the number of radio terminals that may perform the onload process is also large. Thus, even if the radio base station 100-2 has a low load, the radio base station 100-2 is also capable of transmitting the response to reject the handover request to the radio base station 100-1 so as to deal with a rapid increase in loads.

The radio base station 100-1 that receives the response to reject the handover request, which does not know a situation of the radio base station 100-2, may repeatedly transmit the handover request to the radio base station 100-2 until the handover request is approved. As a result, an unnecessary handover request transmission may be performed.

On the other hand, as illustrated in FIG. 6, a case is assumed where the radio base station 100-2 approves the handover request. In this case, the radio base station 100-2 sets the determination parameter to a value by which an offload process is performed easily, and thus, it is highly likely that the radio terminal 10 immediately performs the offload process on the basis of the determination parameter of the radio base station 100-2. As illustrated in FIG. 6, in a case where the access point 200 is in the overlapping portion between the first coverage area 100A-1 and the first coverage area 100A-2, the radio terminal is capable of performing the offload process even if not performing the handover, and thus, it is likely that an unnecessary handover request transmission is performed.

To avoid such an unnecessary handover request transmission, in the present embodiment, the radio base station 100-2 transmits status information indicating whether or not the load distribution control is being performed, to the radio base station 100-1. Thus, the radio base station 100-1 knows that the radio base station 100-2 is performing the load distribution control. Therefore, the radio base station 100-1 is capable of determining whether or not to transmit the handover request after considering that the radio base station 100-2 is performing the load distribution control. As a result, it is possible to reduce an unnecessary handover request transmission.

An example of a detailed operation according to the present embodiment will be described, below.

As illustrated in FIG. 7, the radio base station 100-2 transmits a resource status update message (RESOURCE STATUS UPDATE) to the radio base station 100-1. The resource status update message includes status information indicating that the load distribution control is being performed. The status information may be information indicating that the determination parameter is set to a value by which an offload process is performed easily (Aggressive WLAN offloading status).

The status information may include information indicating a degree of the load distribution control. For example, the information indicating the degree of the load distribution control may be information indicating a class (“High, Middle, Low”, “integer value (0 to 100) and the like) categorized depending on a level of the load distribution control. The information indicating the degree of the load distribution control may be a value indicating the determination parameter actually set as a value by which an offload process is performed easily.

The status information may include information indicating a type of setting of the determination parameter. Specifically, if notifying, by SIB, the radio terminal 10 of the determination parameter (broadcast parameter), the radio base station 100-2 may include information (SIB setting) indicating that the determination parameter is set by SIB to the radio terminal. If notifying, by dedicated signaling, the radio terminal 10 of the determination parameter (individual parameter), the radio base station 100-2 may include information (RRC setting) indicating that the determination parameter is set by the dedicated signaling to the radio terminal. These pieces of information may be indicated by a flag indicating “0 (setting)”, “1 (non-setting)”. The status information may include information indicating the degree of the load distribution control in each of the “SIB setting” and the “RRC setting”.

The status information may include information indicating the number of radio terminals to which the determination parameter is set by the dedicated signaling. Such information may be the number of such radio terminals per unit time period. Alternatively, the status information may be information indicating the number of radio terminals that perform the offload process. Such information may be the number of such radio terminals per unit time period. For example, if approving the offload process, the radio base station 100-2 is capable of considering the number of approved radio terminals as the number of radio terminals that perform the offload process. It is noted that if the access point 200 receives a message (association/authentication request, for example) about a connection request from the radio terminal 10 that exists in a cell of the radio base station 100-2, on the basis of a message transmitted from the access point 200 to the radio base station 100-2, the radio base station 100-2 determines whether or not to approve the offload process. Further, the status information may include information indicating an identifier of the access point 200 in the WLANID list. Such information may be the WLANID list itself.

It is noted that the resource status update message includes information indicating a load of the base station itself, and thus, the radio base station 100-2 transmits, together with the load information of the radio base station 100-2, the status information to the radio base station 100-1. In the load information, which is in particular a measurement result of a load for each cell (Cell Measurement Result), a cell identifier and specific load information are associated. Examples of the specific load information include Hardware Load, S1 TNL Load, Radio Resource Status, Composite Available Capacity Group, and ABS Status.

The radio base station 100-1 that receives the resource status update message is capable of determining on the basis of the status information included in the resource status update message whether or not to transmit the handover request to the radio base station 100-2. For example, if the status information is included in the resource status update message, the radio base station 100-1 may determine to not transmit the handover request to the radio base station 100-2.

Alternatively, if the status information is included in the resource status update message and the load distribution is a purpose of the handover request, the radio base station 100-1 may determine to not transmit the handover request to the radio base station 100-2. Even if the status information is included in the resource status update message but the handover request is related to movement of the radio terminal 10 (the handover request seeks mobility control), the radio base station 100-1 may determine to transmit the handover request to the radio base station 100-2 in order to maintain a radio communication quality of the radio terminal 10.

Alternatively, the radio base station 100-1 may make a determination in consideration not only of the status information but also of the load information. Specifically, the radio base station 100-1 may make a determination after comparing the load information of the radio base station 100-2 and the load information of the radio base station 100-1.

Alternatively, the radio base station 100-1 is capable of determining, in consideration of each of the above-described information included in the status information, whether or not to transmit the handover request to the radio base station 100-2. For example, if the degree of the load distribution control is small, the radio base station 100-1 may determine to transmit the handover request to the radio base station 100-2. Further, if the number of radio terminals to which the determination parameter is set by the dedicated signaling and/or the number of radio terminals that performs the offload process are/is small (the number of radio terminals is smaller than a threshold value), the radio base station 100-1 may determine to transmit the handover request to the radio base station 100-2.

Alternatively, the radio base station 100-1 allows the radio terminal 10 to perform the offload process by changing, on the basis of the value of the determination parameter included in the status information and/or the identifier of the access point 200, the setting of the determination parameter of the radio terminal 10 being an object of the handover, without transmitting the handover request. As a result, the handover request and the signaling in a handover procedure are not transmitted, and thus, it is possible to reduce the signaling. Further, the radio terminal 10 does not perform the offload process immediately after performing the handover, and thus, it is also possible to restrain a reduction of service quality (QoE).

### Second Embodiment

Next, an operation according to a second embodiment will be described by using FIG. 5. Similar portions to the above-described first embodiment will not be described where appropriate.

In the first embodiment, the information indicating that the load distribution control (status information) is being performed is included in the resource status update message. In the second embodiment, the information indicating that the load distribution control is being performed is included in a negative acknowledgment to reject the handover request.

As illustrated in FIG. 5, a case is assumed where the radio base station 100-2 that receives the handover request from the radio base station 100-1 transmits, in order to reject the handover request, a negative acknowledgment that is a response to the handover request. In this case, the radio base station 100-2 transmits a negative acknowledgment including a rejection reason indicating that the load distribution control is being performed. The negative acknowledgment may include at least any of various types of information included in the resource status update message in the first embodiment.

As a result, in much the same way as in the first embodiment, after considering the rejection reason (and various types of information), the radio base station 100-1 is capable of determining whether or not to transmit again the handover request to the radio base station 100-2. The radio base station 100-1 that knows by the rejection reason a situation of the radio base station 100-2 is capable of determining to transmit the handover request to another radio base station 100 rather than transmitting again the handover request to the radio base station 100-2, for example. Alternatively, in order that the radio terminal 10 is allowed to transmit the message about the connection request to the access point 200, the radio base station 100-1 may notify, by the RRC message, the radio terminal 10 of the determination parameter (individual parameter) of a value by which an offload process is performed easily.

[Modification of Second Embodiment]

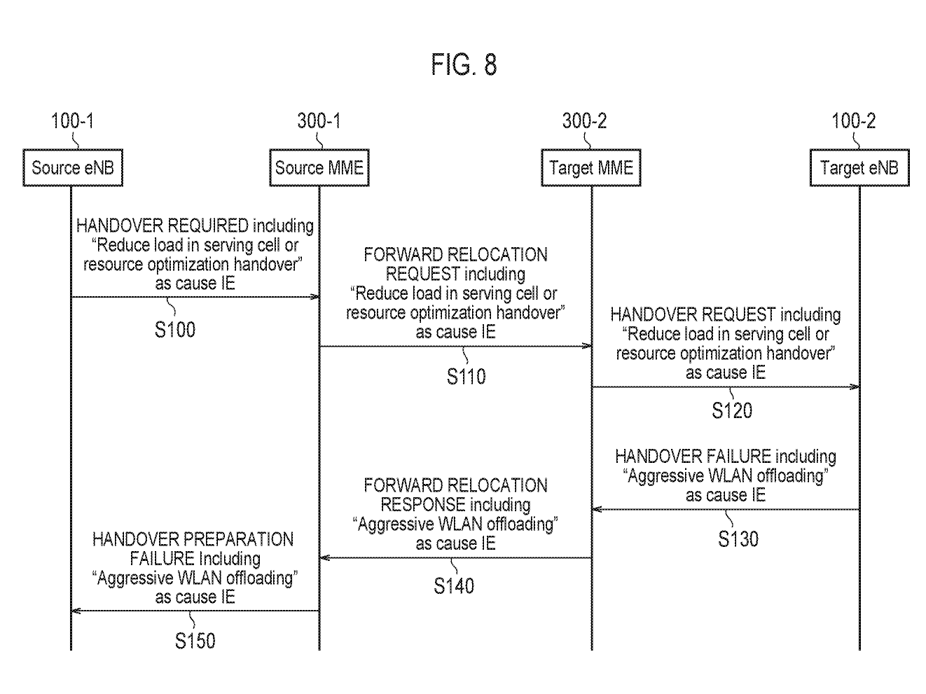

Next, an operation according to a modification of the second embodiment will be described by using FIG. 8. FIG. 8 is a diagram for describing an example of an operation according to the modification of the second embodiment. Similar portions to the above-described first embodiment and second embodiment will not be described where appropriate.

In the second embodiment, a case of an X2 handover is concerned. In the modification of the second embodiment, a case of an S1 handover is concerned.

As illustrated in FIG. 8, in step S100, a radio base station (Source eNB) 100-1 that is a source base station transmits the handover request to an MME (Source MME) 300-1 that is an upper station of the radio base station 100-1. The handover request includes, as a reason for a handover request (cause IE), information indicating a load reduction of a serving cell (Reduce load in serving cell) or optimization of a resource by a handover (resource optimization handover).

In step S110, the MME 300-1 that receives the handover request transmits a transfer relocation request (FORWARD RELOCATION REQUEST) to an MME (Target MME) 300-2 that is an upper station of a radio base station (Target eNB) 100-2 that is a target base station. The transfer relocation request includes the reason for the handover request.

In step S120, the MME 300-2 that receives the transfer relocation request transmits the handover request to the radio base station 100-2. The handover request includes a reason to be included in the transfer relocation request.

In much the same way as in the first embodiment, a case is assumed where the radio base station 100-2 is performed the load distribution control (Aggressive WLAN offloading).

The radio base station 100-2 that receives the handover request determines whether to approve or reject the handover request. For example, the radio base station 100-2 may determine to reject the handover request if the load distribution is a purpose of the handover request. It is noted that in the handover request whose reason is to reduce a load of a serving cell and optimize the resource by the handover, the load distribution is sought.

Description proceeds with an assumption that the radio base station 100-2 determines to reject the handover request.

In step S130, the radio base station 100-2 that receives the handover request transmits, to the MME 300-2, a negative acknowledgment (HANDOVER FAILURE) to reject the handover request. The negative acknowledgment includes a rejection reason indicating that the load distribution control (Aggressive WLAN offloading) is being performed. The radio base station 100-2 may include the rejection reason indicating that the load distribution control is being performed, into the negative acknowledgment, if the load distribution is a purpose of the handover request.

In step S140, the MME 300-2 that receives the negative acknowledgment transmits a response (FORWARD RELOCATION RESPONSE) to the transfer relocation request, to the MME 300-1. The response includes a rejection reason indicating that the load distribution control (Aggressive WLAN offloading) is being performed.

In step S150, the MME 300-1 that receives a response to the transfer relocation request transmits a response (HANDOVER PREPARATION FAILURE) to the handover request, to the radio base station 100-1. The response includes a rejection reason indicating that the load distribution control (Aggressive WLAN offloading) is being performed.

As a result, the radio base station 100-1 is capable of knowing that the radio base station 100-2 is performed the load distribution control (Aggressive WLAN offloading). Thus, it is possible to reduce the signaling not only by the X2 handover but also by the S1 handover.

### Other Embodiments

The contents of the present application are described through each of the above-described embodiments, but it should not be understood that the discussion and the drawings constituting a part of this disclosure limit to the contents of the present application. From this disclosure, various alternative embodiments, examples, and operational technologies will be obvious to those skilled in the art.

In each of the above-described embodiments, description proceeds with a case where the radio base station 100-2 sets, as the load distribution control, the determination parameter to a value by which an offload process is performed easily (Aggressive WLAN offloading case); however, this is not limiting. In a case where the radio base station 100-2 is performing control in which the predetermined radio terminal 10 in the cell of the radio base station 100-2 is allowed to perform the handover (Aggressive HO case), the radio base station 100-2 may transmit, to the radio base station 100-1, information indicating that the control in which the predetermined radio terminal 10 in the cell of the radio base station 100-2 is allowed to perform the handover (Aggressive HO) is being performed. Further, if the both control operations is being performed, the radio base station 100-2 may transmit information indicating that the load distribution control is being performed (Aggressive WLAN offloading & Aggressive HO), to the radio base station 100-1.

For example, the radio base station 100-2 that is performing the load distribution control performs control so that the radio terminal (predetermined radio terminal) 10 that transmits a measurement report indicating that a received signal strength from a neighboring base station 100 is higher than a predetermined threshold value is allowed to perform the handover. In this case, the radio base station 100-2 decides to allow the predetermined radio terminal 10 to perform the handover, and performs a normal handover procedure.

It is noted that the predetermined threshold value is a value by which the radio terminal 10 easily performs the handover, and is a value lower than a (normal) threshold value when not performing the load distribution control used for determination in which the radio terminal 10 is allowed to perform the handover. The predetermined threshold value may be a threshold value for the load distribution control. It is noted that in the radio base station 100-2 that is performing control to maintain the communication quality of the radio terminal 10 at a high level, the predetermined threshold value (threshold value for the load distribution control) is a value lower than a threshold value by which the communication quality is maintained at a high level; however, the value should be a value larger than a threshold value by which it is possible to maintain a minimum level of the communication quality.

In each of the aforementioned embodiments, the radio base station 100-2 is not limited to a case where the base station itself has a high load. For example, when a load balance with another node (neighboring base station 100 and/or the access point 200 is maintained by performing the load distribution control, the radio base station 100-2 may transmit information indicating that the load distribution control is being performed, to the radio base station 100-1.

Although not particularly mentioned in the embodiments, a program may be provided to cause a computer to execute each process performed by any one of the radio terminal 10, the radio base station 100, and the access point 200. Further, the program may be recorded on a computer-readable medium. By using the computer-readable medium, it is possible to install the program in a computer. Here, the computer-readable medium recording the program thereon may include a non-transitory recording medium. The non-transitory recording medium is not particularly limited; the non-transitory recording medium may include a recording medium such as a CD-ROM or a DVD-ROM, for example.

Alternatively, a chip may be provided which is configured by: a memory that stores therein a program for executing each process performed by any one of the radio terminal 10, the radio base station 100, and the access point 200; and a processor for executing the program stored in the memory.

In each embodiment, the LTE is exemplified as the mobile communication network. However, the embodiment is not limited thereto. It may suffice when the mobile communication network is a network provided by a communication carrier. Therefore, the mobile communication network may be a UMTS (Universal Mobile Telecommunication System) or may be GSM (registered trademark).

In addition, the entire content of JP Patent Application No. 2014-227438 (filed on Nov. 7, 2014) is incorporated in the present specification by reference.

1. A base station that constitutes a mobile communication network, comprising:
a controller configured to perform at least either one of load distribution controls of a first control in which a parameter is set to a value by which switching from the mobile communication network to a wireless LAN is performed easier than a predetermined value or a second control in which a predetermined radio terminal, out of radio terminals subordinate to the base station, is allowed to perform handover; and
a transmitter configured to transmit status information indicating whether or not the base station is performing the load distribution control, to a neighboring base station, wherein
the parameter is used for determining whether or not the radio terminal subordinate to the base station switches a standby target or a connection target between the mobile communication network and the wireless LAN.

2. The base station according to claim 1, wherein the transmitter transmits the status information to the neighboring base station together with load information of the base station.

3. The base station according to claim 1, wherein the status information includes information indicating a degree of the load distribution control.

4. The base station according to claim 1, wherein the status information is information indicating that the first control is being performed and/or information indicating that the second control is being performed.

5. The base station according to claim 1, wherein if the load distribution control is the first control, the status information includes information indicating the parameter.

6. The base station according to claim 1, wherein if the load distribution control is the first control, the status information includes information indicating the number of radio terminals to which the parameter is set by a dedicated signal.

7. The base station according to claim 1, wherein if the load distribution control is the first control, the status information includes information indicating the number of radio terminals that perform the switching.

8. The base station according to claim 1, wherein if the load distribution control is the first control, the status information includes an identifier indicating a wireless LAN access point that is a candidate of the standby target or the connection target.

9. A base station that constitutes a mobile communication network, comprising:
a controller configured to perform at least either one of load distribution controls of a first control in which a parameter is set to a value by which switching from the mobile communication network to a wireless LAN is performed easier than a predetermined value or a second control in which a predetermined radio terminal, out of radio terminals subordinate to the base station, is allowed to perform handover;
a receiver configured to receive a handover request from another base station; and
a transmitter configured to transmit, if rejecting the handover request, a response to the handover request, where the response is a negative acknowledgment including a rejection reason indicating that the load distribution control is being performed, wherein
the parameter is used for determining whether or not the radio terminal subordinate to the base station switches a standby target or a connection target between the mobile communication network and the wireless LAN.

10. The base station according to claim 9, wherein the transmitter transmits, if a reason for the handover request is a load distribution, the negative acknowledgment including the rejection reason indicating that the load distribution control is being performed.

11. A processor configured to control a base station that constitutes a mobile communication network, wherein the processor executes:
a process of performing at least either one of load distribution controls of a first control in which a parameter is set to a value by which switching from the mobile communication network to a wireless LAN is performed easier than a predetermined value or a second control in which a predetermined radio terminal, out of radio terminals subordinate to the base station, is allowed to perform handover; and
a process of transmitting status information indicating whether or not the base station is performing the load distribution control, to a neighboring base station, wherein
the parameter is used for determining whether or not the radio terminal subordinate to the base station switches a standby target or a connection target between the mobile communication network and the wireless LAN.

12. A processor configured to control a base station that constitutes a mobile communication network, wherein the processor executes:
a process of performing at least either one of load distribution controls of a first control in which a parameter is set to a value by which switching from the mobile communication network to a wireless LAN is performed easier than a predetermined value or a second control in which a predetermined radio terminal, out of radio terminals subordinate to the base station, is allowed to perform handover;
a process of receiving a handover request from another base station; and
a process of transmitting, if rejecting the handover request, a response to the handover request, where the response is a negative acknowledgment including a rejection reason indicating that the load distribution control is being performed, wherein
the parameter is used for determining whether or not the radio terminal subordinate to the base station switches a standby target or a connection target between the mobile communication network and the wireless LAN.
